(19) United States
(12) Patent Application Publication
(10) Pub. No.: US 2009/0308965 A1
(43) Pub. Date: Dec. 17, 2009

(54) Machine, method, and system for severing a web

(75) Inventors: Vincent A. Piucci, Spencer, MA (US); Michael J. Schamel, Wilmont, NH (US)

Correspondence Address: Sealed Air Corporation, P.O. Box 464, Duncan, SC, 29334, US

(73) Assignee: Sealed Air Corporation (US)

(21) Appl. No.: 12/214,198

(22) Filed: Jun. 17, 2008

(51) Int. Cl. B65H 35/08; B26D 5/20

(52) U.S. Cl. 242/526; 83/353

(57) ABSTRACT

A machine, system and method for severing a web having a series of containers, wherein the containers are spaced apart and linked together by a series of connectors disposed between the containers. The machine generally includes a rotary device having a plurality of spaced-apart standoff members extending radially outwards to contact the web at the connectors such that rotational movement of the rotary device causes movement of the web; a severing mechanism including a movable severing device that is adapted to urge the web against one of the standoff members to thereby effect severance of the web; and a control system comprising an operator interface to allow a specified number of containers to be selected for severance from the web.

### BACKGROUND OF THE INVENTION

The present invention relates to a machine for severing a web of material and, more particularly, to a simplified and improved machine, method, and system for severing a web of material containing a series of containers, especially inflated, gas-containing containers in the form of packaging cushions.

There often arises a need to sever a predetermined number of inflated packaging cushions from a web containing a connected string of such cushions. For example, articles to be shipped in a box are often wrapped or braced with cushioning material inside of the box in order to protect the article during shipment. Such material often is supplied in the form of a continuous web from a source such as, e.g., an apparatus that creates such material.

Typically, between each inflated container is a line of perforations that allows the packaging operator to manually tear a desired number of cushions from the web of containers. This is a tedious, repetitive action that the operator must perform all day.

Accordingly, there is a need in the art for a machine that allows a packaging operator to select a desired number of containers for severance from a web, and then severs such number of containers from the web.

### SUMMARY OF THE INVENTION

That need is met by the present invention, which, in one aspect, provides a machine for severing a web comprising a series of containers, the containers being spaced apart and linked together by a series of connectors disposed between the containers, the machine comprising:

a. a rotary device comprising a plurality of spaced-apart standoff members extending radially outwards to contact the web at the connectors such that rotational movement of the rotary device causes movement of the web;

b. a severing mechanism including a movable severing device that is adapted to urge the web against one of the standoff members to thereby effect severance of the web; and

c. a control system comprising an operator interface to allow a specified number of containers to be selected for severance from the web, the control system being operative to:
(1) identify a designated connector for severance which corresponds to the selected number of containers to be severed from the web,
(2) cause the rotary device to bring the designated connector into a position for severance, in which the designated connector is supported by one of the standoff members and is located proximate the severing mechanism, and
(3) cause the severing mechanism to move the severing device such that the severing device urges the designated connector against the supporting standoff member, thereby severing the web at the designated connector.

Another aspect of the invention is directed towards a system for making and severing a web comprising a series of containers, comprising:

a. an apparatus for making the web, the containers being spaced apart and linked together by a series of connectors disposed between the containers; and

b. a machine for severing the web, as described above.

A further aspect of the invention is directed towards a method for severing a web comprising a series of containers, the containers being spaced apart and linked together by a series of connectors disposed between the containers, the method comprising:

a. contacting the web with a rotary device comprising a plurality of spaced-apart standoff members extending radially outwards, the standoff members contacting the web at the connectors such that rotational movement of the rotary device causes movement of the web;

b. selecting a specified number of containers for severance from the web;

c. identifying a designated connector for severance, which corresponds to the selected number of containers to be severed from the web;

d. moving the web until the designated connector is placed into a position for severance, in which the designated connector is supported by one of the standoff members and is located proximate a severing mechanism, the severing mechanism including a movable severing device; and

e. moving the severing device such that the severing device urges the designated connector against the supporting standoff member, thereby severing the web at the designated connector.

These and other aspects and features of the invention may be better understood with reference to the following description and accompanying drawings.

### BRIEF DESCRIPTION OF THE DRAWING

FIG. 1 is a schematic view of a machine 10 for severing a web in accordance with the present invention, including a rotary member and severing mechanism;

FIG. 2 is a perspective view of the web shown in FIG. 1, which includes a series of containers;

FIG. 3 is a perspective view of two different rotary members, which have different spacings between standoff members to accommodate webs having different-sized containers;

FIG. 4 is a schematic view of a rotary member for use in machine 10, showing various dimensional relationships between the components of the rotary member;

FIG. 5 is a perspective view of an embodiment of a standoff member that may be used as a component of any of the rotary members described above;

FIG. 6 is a side, elevational view of a rotary member and severing mechanism in accordance with the present invention, wherein the severing mechanism is in a position to allow the rotary member to rotate;

FIG. 7 is similar to FIG. 6, except that the severing mechanism is shown in a position to sever a web conveyed by the rotary member;

FIG. 8 is similar to FIG. 6, except that a web is shown on the rotary member;

FIG. 9 is similar to FIG. 7, except that a web is shown on the rotary member;

FIG. 10 is an elevational view of a system for making and severing a web, including an apparatus 32 for making the web and machine 10 for severing the web; and

FIG. 11 is a schematic view of a control system that may be employed in association with machine 10.

### DETAILED DESCRIPTION OF THE INVENTION

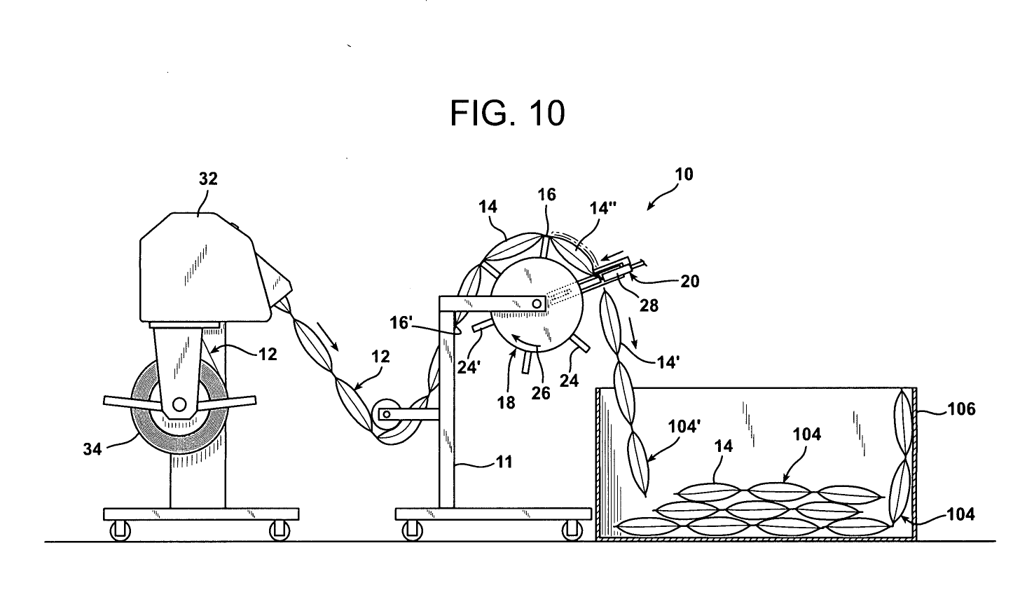

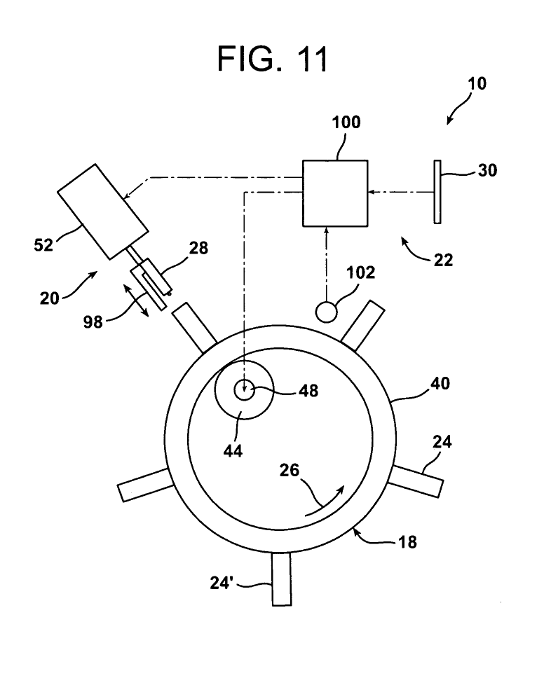

FIGS. 10-11 schematically illustrate a machine 10 in accordance with the present invention for severing a web 12 comprising a series of containers 14. The containers 14 are spaced apart and linked together by a series of connectors 16 disposed between the containers.

Machine 10 generally comprises a rotary device 18, a severing mechanism 20, and a control system 22. As shown in FIG. 10, machine 10 may be conveniently supported on a wheel-mounted stand 11 or the like. The machine 10 could also be mounted on a desk, table, wall, etc.

Rotary device 18 includes a plurality of spaced-apart standoff members 24 extending radially outwards to contact the web 12 at the connectors 16 such that rotational movement 26 of the rotary device 18 causes movement of the web 12.

Severing mechanism 20 includes a movable severing device 28 that is adapted to urge the web 12 against one of the standoff members 24 to thereby effect severance of the web.

Control system 22 includes an operator interface 30 to allow a specified number of containers to be selected for severance from the web 12.

As illustrated, containers 14 on web 12 may comprise gas-filled packaging cushions, which have been inflated and sealed closed prior to their introduction to machine 10. Web 12 may thus comprise an inflatable cushioning web that is inflated and sealed at a different site or at the same site as machine 10.

FIG. 10 illustrates the production of inflated containers 14 at the same site as machine 10, wherein machine 10 is supplied with such containers from an inflation/sealing apparatus 32. The containers 14 may be supplied to machine 10 directly as shown, i.e., as part of a system for making and severing web 12 comprising a series of containers 14, which includes apparatus 32 for making the web and machine 10 for severing the web. Alternatively, the web 12 may be supplied to machine 10 indirectly, e.g., via a hopper or supply roll containing previously made containers.

Inflatable cushioning material of this type, as well as machines and methods for its inflation, are well-known, e.g., as disclosed in U.S. Pat. Nos. 6,598,373, 6,804,933, 7,225,599, and in U.S. Ser. No. 10/979,583 (Pub. No. 2006/0090421-A1), the entire disclosures of which are hereby incorporated herein by reference thereto. As illustrated, the web 12 may be supplied in pre-inflated form to apparatus 32 from a supply roll 34 of such material. In such pre-inflated form, the web comprises a series of un-inflated containers. The apparatus 32 then inflates and seals closed the containers in the web to produce a series of inflated containers 14 as shown.

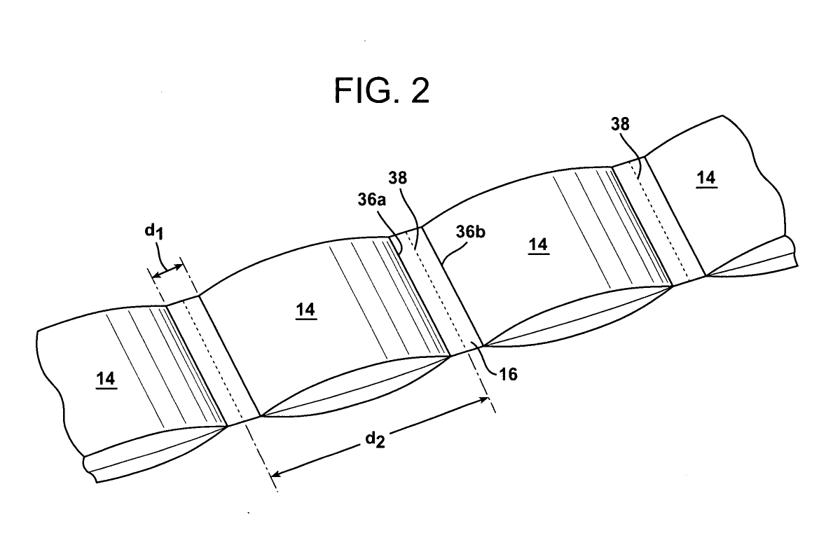

FIG. 2 illustrates a segment of such series of inflated containers 14. Between each of the inflated containers 14 is a connector 16, which is an un-inflated section of web 12 created by a pair of seals 36a, b. Seals 36a, b define the ‘downstream’ and ‘upstream’ ends, respectively, of each inflated container 14. Lines 38 represent the centerline of the connectors 16, i.e., a line that is midway between the seals 36a, b of each connector 16. Conventionally, a line of perforations is positioned along or proximate to the centerline 38, either by apparatus 32 or prior to web 12 being wound on supply roll 34, to allow a packing operator to tear individual containers from the web. If desired, these perforations can be eliminated from web 12 for use in machine 10, but they cause no harm if retained.

In some embodiments the width of the standoff members 24 is selected to correspond to the distance d₁ between seals 36a, b. Similarly, the spacing between the standoff members 24 may be selected to correspond to the distance d₂ between the centerlines 38 of adjacent connectors 16. Distance d₂ thus represents a length dimension for each container 14, which varies depending upon whether the containers are inflated or un-inflated. For example, a container 14 having a length d₂ of 5 inches in an un-inflated state may have a length d₂ of 4.5 inches when such container is inflated. Similarly, un-inflated container lengths 8 and 12 inches may correspond to inflated container lengths of 7.5 and 11.5 inches, respectively.

Web 12 may, in general, comprise any flexible material that can be manipulated by machine 10 as herein described, including various thermoplastic materials, e.g., polyethylene homopolymer or copolymer, polypropylene homopolymer or copolymer, etc. Non-limiting examples of suitable thermoplastic polymers include polyethylene homopolymers, such as low density polyethylene (LDPE) and high density polyethylene (HDPE), and polyethylene copolymers such as, e.g., ionomers, EVA, EMA, heterogeneous (Zeigler-Natta catalyzed) ethylene/alpha-olefin copolymers, and homogeneous (metallocene, single-cite catalyzed) ethylene/alpha-olefin copolymers. Ethylene/alpha-olefin copolymers are copolymers of ethylene with one or more comonomers selected from C₃ to C₂₀ alpha-olefins, such as 1-butene, 1-pentene, 1-hexene, 1-octene, methyl pentene and the like, in which the polymer molecules comprise long chains with relatively few side chain branches, including linear low density polyethylene (LLDPE), linear medium density polyethylene (LMDPE), very low density polyethylene (VLDPE), and ultra-low density polyethylene (ULDPE). Various other polymeric materials may also be used such as, e.g., polypropylene homopolymer or polypropylene copolymer (e.g., propylene/ethylene copolymer), polyesters, polystyrenes, polyamides, polycarbonates, etc. The web may be a monolayer or multilayer film, may contain one or more foamed layers, and may be produced by any known extrusion process, e.g., by melting the component polymer(s) and extruding, coextruding, or extrusion-coating them through one or more flat or annular dies.

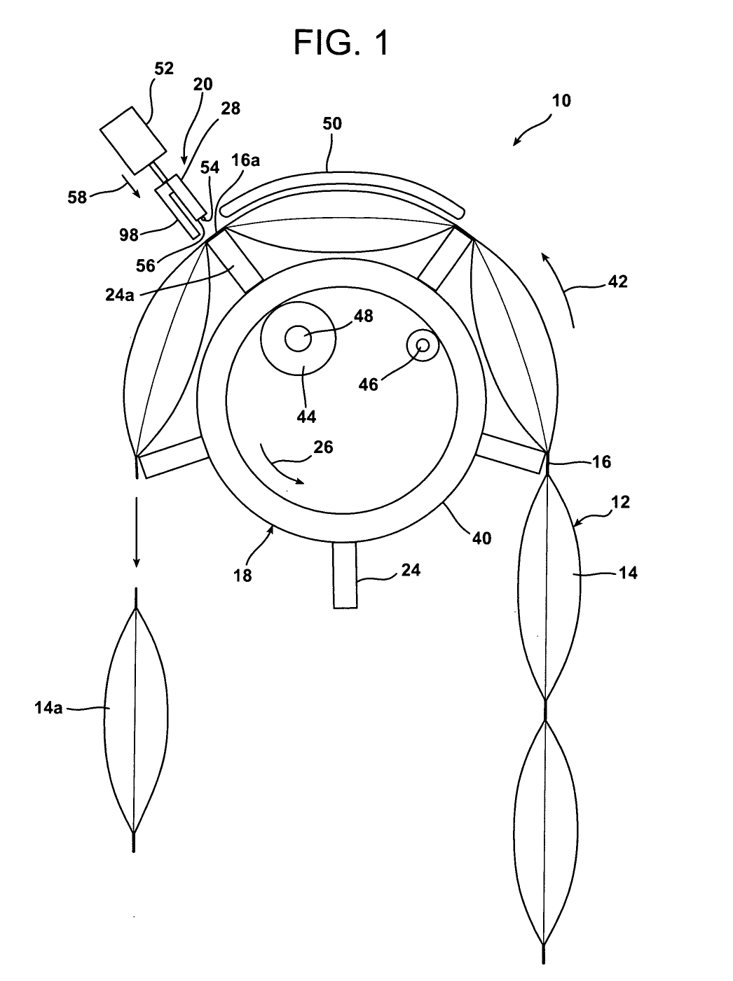

With additional reference to FIG. 1, rotary device 18 will now be described in further detail. In the illustrated embodiment, rotary device 18 includes a cylinder 40, to which the standoff members 24 are affixed, and from which the standoff members extend radially outwards. When the rotary device 18 rotates in the direction of arrow 26, the web 12 of containers 14 moves in the direction of arrow 42 (note that the direction of arrow 26 in FIG. 1 is the reverse of that depicted in FIG. 10, as the view of rotary device 18 in FIG. 1 is from the opposing side of rotary device 18 as shown in FIG. 10; this is to more clearly show the internal components of the rotary device in FIG. 1). Such movement 42 results from the contact between the connectors 16 of web 12 and the standoff members 24.

The rotation of rotary device 18 may be produced by any suitable drive means. For example, an internal drive mechanism may be employed within cylinder 40, which may include a drive wheel 44 and a supporting idler roller 46, both of which may be positioned within cylinder 40 as shown in FIG. 1. Drive wheel 44 may be driven by a motor or the like, e.g., a motor 48, which may be internally positioned within cylinder 40 and axially aligned with drive wheel 44 as shown.

With continued reference to FIG. 1, it may be seen that a top cover 50 may be included in or associated with machine 10, which may serve to loosely hold the containers 14 in place between the standoff members 24, e.g., by force of gravity acting on the top cover 50 to weigh down the containers as the containers move slidingly past the cover. This may be useful when containers 14 are gas-filled packaging cushions, i.e., in order to hold such relatively light-weight containers in place, which could otherwise be moved via air currents in the ambient environment. The top cover 50 may be rigidly or pivotally attached, e.g., to stand 11.

Severing mechanism 20 may include an actuator 52 and a movable severing device 28 as shown. The severing device 28 may comprise any conventional device for severing a web of material, e.g., a heating element such as one or more wires, knives, bands, or other electrically-heatable material; a cutting element such as a guillotine-type knife, a rolling blade, a swinging blade, a translating blade, a serrated blade; etc. In the presently-illustrated embodiment, severing device 28 includes a heating element 54 capable of reaching a temperature sufficient to sever web 12. Such a heating element may be a resistance wire as shown, which may be positioned on the front or contact edge 56 of severing device 28, and which may comprise a nickel-chromium alloy.

The function of severing mechanism 20 is to sever web 12. This may be accomplished by causing actuator 52 to move severing device 28 in the direction of arrow 58, i.e., towards web 12. More specifically, the actuator 52 causes severing device 28 to urge web 12 against a standoff member, e.g., the standoff member identified as 24a in FIG. 1, when such standoff member 24a is brought into the position shown in FIG. 1, i.e., proximate the severing mechanism 20. Such urging of the web 12 against standoff member 24a causes heating element 54 to be pressed into the web, which brings about the severance of the web when the heating element 54 is brought to a temperature sufficient to melt through the web.

Preferably, such severance of web 12 occurs at one of the connectors 16. For example, the connector identified as connector 16a in FIG. 1 is in position for severance, as delivered to such position by standoff member 24a. As also shown in FIG. 1, a previously severed container 14a is seen exiting machine 10, e.g., by falling free of the machine via the force of gravity.

The severing mechanism 20 may be configured as illustrated such that the severing device 28 moves in a substantially linear path of travel. In contrast to a pivotal or rotational path of travel, a substantially linear path of travel is advantageous when containers 14 are inflated, e.g., packaging cushions, because such linear movement minimizes the likelihood that the severing device 28, particularly heating element 54 thereof, will make inadvertent contact with and cause deflation of a container 14 while on its travel path towards a connector, e.g., connector 16a as shown in FIG. 1.

In the embodiment described above, the rotary device 18 and severing mechanism 20 are powered by separate drive means, i.e., motor 48 and actuator 52, respectively. As an alternative, a single drive means may be employed to both cause the rotation of rotary device 18 and urge the movable severing device 28 against the web, as disclosed, e.g., in U.S. Ser. No. 11/234,891 (Publication No. 2007/0068353-A1), the entire disclosure of which is hereby incorporated herein by reference thereto.

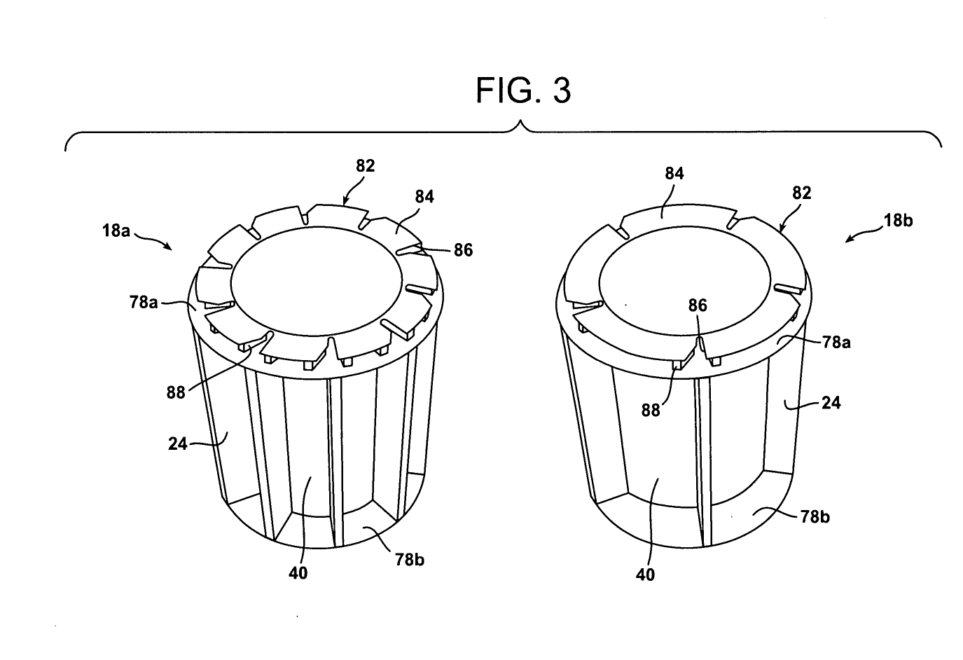

In some embodiments, rotary device 18 may be particularly configured and/or selected for a particular length of cushion. FIG. 3 shows two such rotary devices, 18a and 18b. While both may include cylinders 40 having the same inner diameter, device 18a has more standoff members 24, with a shorter distance between standoff members, than device 18b. Rotary device 18a is thus designed to accommodate a web having a shorter inflated container length d₂ than is device 18b, which is designed to accommodate webs with a longer d₂ inflated container length (see FIG. 2).

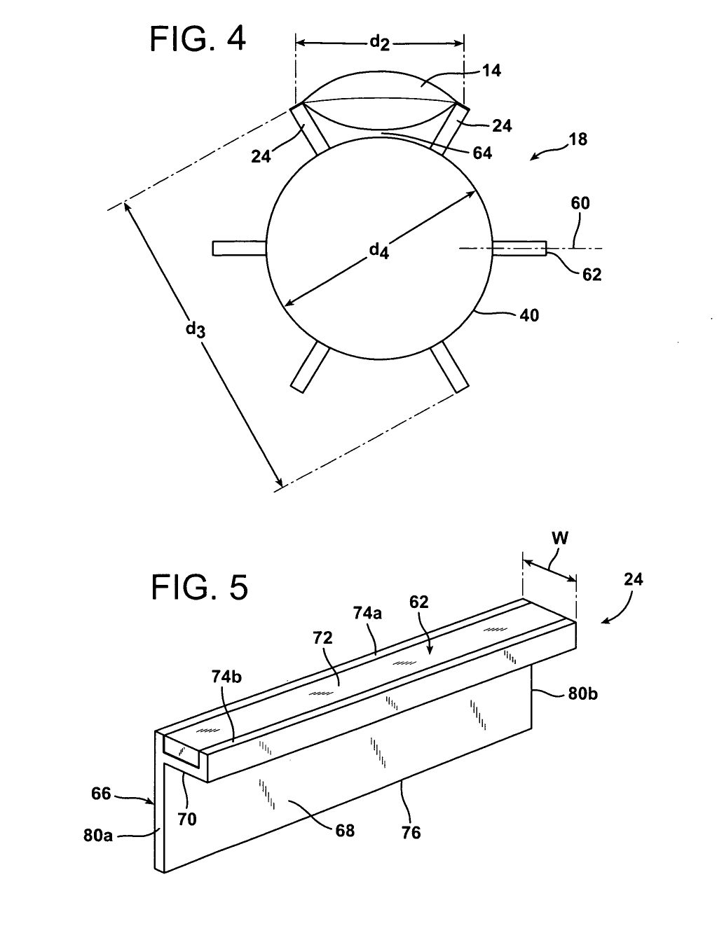

FIG. 4 illustrates some of the dimensional aspects of rotary device 18. For ease of reference, only one inflated container 14 is shown in place between two adjacent standoff members 24, with the inflated length dimension d₂ also shown for such container. Preferably, the linear distance between adjacent standoff members 24 is the same as, or at least close to, the length dimension d₂ of the inflated container with which the rotary member 18 is designed to be used. The proper linear distance between adjacent standoff members may be determined by measuring such distance between the centerlines 60 of the standoff members 24, as taken at the contact surfaces 62 thereof. In this manner, the web 12 may be supported by the standoff members 24 substantially only at the connectors 16.

Preferably, the outer diameter d₃ of rotary device 18, i.e., the outermost diameter of the device, including cylinder 40 and standoff members 24, in conjunction with the diameter d₄ of the cylinder 40, is such that a gap 64 exists between the inflated container 14 and the cylinder 40. The existence of such a gap 64 provides at least some level of assurance that the web 12 is supported by standoff members 24 substantially only at connectors 16, i.e., the inflated containers 14 do not touch the surface of the cylinder 40. Any such contact between the inflated containers 14 and the cylinder 40 could alter the positioning of the connectors 16 vis-à-vis the contact surfaces 62 of the standoff members 24 which, in turn, could adversely impact the severance operation of the severing mechanism 20.

FIG. 5 illustrates an embodiment that may be employed for the standoff members 24 in accordance with the present invention. The standoff member 24 as depicted in FIG. 5 may include an upright structure 66 and a contact surface 62. The upright structure 66 may include a stanchion 68 and a platform 70, wherein the platform 70 is spaced from cylinder 40 by stanchion 68. Contact surface 62 may include an anvil 72, which may be affixed to platform 70. With anvil 72, contact surface 62 may thus provide a support, e.g., a backing, against which severing device 28 urges a designated connector 16 of web 12 during the severance thereof. When the severing device 28 includes a heating element, e.g., heating element 54 as shown in FIG. 1, anvil 72 may advantageously be composed of a heat-resistant material, e.g., a metallic or polymeric material such as Teflon® or other fluorocarbon materials.

Platform 70 may further include a pair of lips 74a, b to add structural strength to the standoff member 24 and to help hold the anvil 72 in place. In the embodiment illustrated in FIG. 5, the width “w” of the contact surface 62, including the combined widths of the anvil 72 and lips 74a, b, may be selected to be the same as or close to, e.g., slightly less than, the distance d₁ between seals 36a, b in web 12 (FIG. 2). In this manner, the contact surfaces 62 of the standoff members 24 will fit properly against the connectors 16.

Both the cylinder 40 and the upright structures 66 may be formed of metal, e.g., perforated metal for weight reduction. Thus, in the construction of rotary device 18, the base 76 of the upright structures 66 may be affixed to cylinder 40, e.g., via welding. With reference back to FIG. 3, end plates 78a, b may also be included. Such end plates may be welded to the cylinder 40, and also to the ends 80a, b of the upright structures 66 (FIG. 5) in order to provide additional stability and support thereto.

In some embodiments of the invention, machine 10 may include an alignment member 82 to align the severing device 28 with one of the standoff members 24 during severance of the web 12. As shown in FIG. 3, such alignment member 82 may take the form of a guide ring 84 with shaped guide slots 86. As shown, the slots 86 are arrayed on guide ring 84 such that their locations on the guide ring correspond to the positions of the standoff members 24 on cylinder 40. The guide ring 84 may be affixed to one of the end plates, e.g., end plate 78a as shown, via anchors 88, which may also serve to space the guide ring 84 from the end plate.

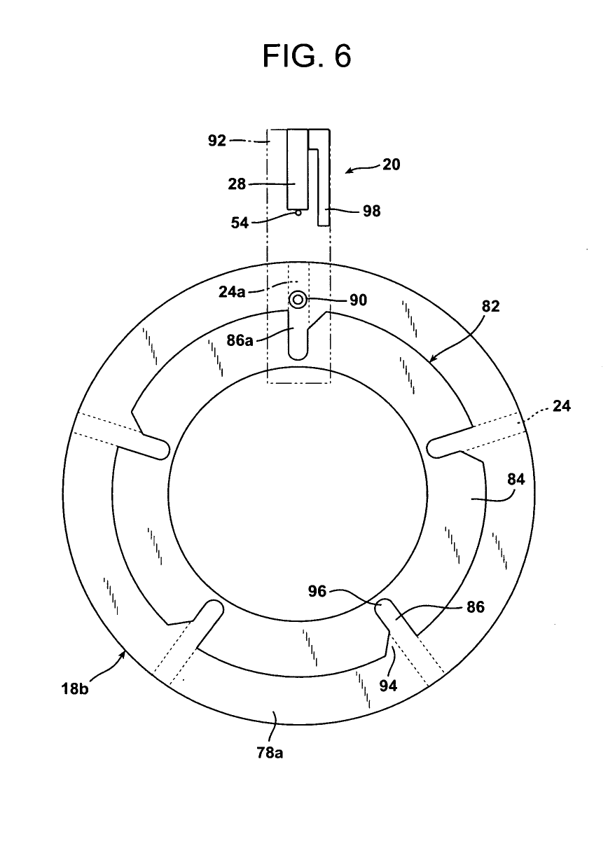

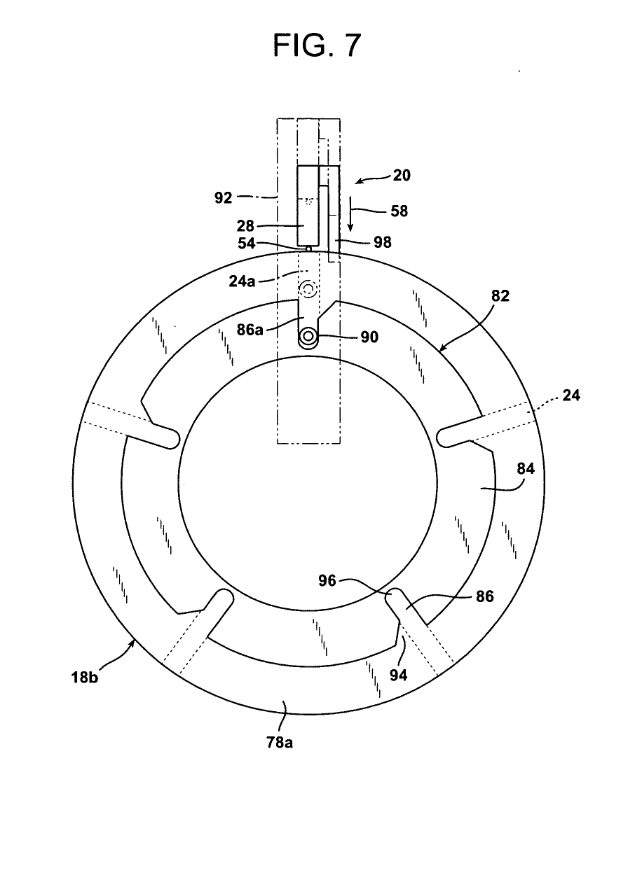

With additional reference to FIGS. 6-7, severing mechanism 20 may further include a cam follower 90, which may be affixed to the severing device 28 via an attachment bar 92 (shown in phantom line for clarity). For illustration purposes, rotary device 18b is shown in FIGS. 6-7 (see FIG. 3). In FIG. 6, the rotary device 18b has brought one of the standoff members 24, e.g., standoff member 24a, into position for severance of a connector (not shown) that is in contact with the standoff member, i.e., by stopping such that the standoff member 24a is proximate the severing mechanism 20.

In FIG. 7, severing device 28 is moved in the direction of arrow 58 towards standoff member 24 such that the heating element 54 is urged against the standoff member. During this movement, alignment of the severing device 28 with standoff member 24a is facilitated by the cooperation of the cam follower 90 with the alignment member 82. When the severing device 28 is moved into contact with one of the standoff members 24, e.g., standoff member 24a as in FIG. 7, the cam follower 90 fits into the corresponding guide slot 86, e.g., slot 86a as shown. Thus, when the cam follower 90 is positioned on the attachment bar 92 such that it is aligned with heating element 54, and guide slot 86a is aligned with the corresponding standoff member 24a, the movement of the cam follower 90 within the guide slot 86 effectively forces the heating element 54 into contact with standoff member 24a, e.g., along centerline 60 of the standoff member (see FIG. 4).

If desired, guide slots 86 may be shaped such that they have a wide opening at the entrance 94, which tapers, e.g., half way down the length of the slot, such that the width at and/or near the end portion 96 of the slot is only slightly wider than the cam follower 90. Further the end portion 96 is preferably aligned with the corresponding standoff member 24. In this manner, when the rotary device 18b brings the standoff member 24a into position for severance, the accuracy of the stopping location need only be enough to place the cam follower 90 at any point above the widened entrance 94 of the guide slot 86. That is, as the severing device 28 is moved towards the standoff member 24a, if the cam follower 90 is above the tapered portion of the widened entrance 94, but not above the narrower end portion 96, contact between the cam follower 90 and the tapered portion of the guide slot 86 will move the rotary device 18 in a clockwise direction (as viewed in FIG. 7), until the end portion 96 of the slot is brought into alignment with the cam follower; this, in turn, brings the heating element 54 of severing device 28 into alignment with standoff member 24a.

Accordingly, it may appreciated that alignment member 82 advantageously guides the severing device 28 into contact with a desired one of the standoff members 24 during severance of the web 12. This facilitates the severance of the web 12 at a connector 16, which is supported by a standoff member, and helps to prevent inadvertent severance of the web within one of the containers 14. On the other hand, when the severing device 28 is in the position shown in FIG. 6, the cam follower 90 is outside the periphery of guide ring 84, thereby allowing the rotary device 18 to rotate freely.

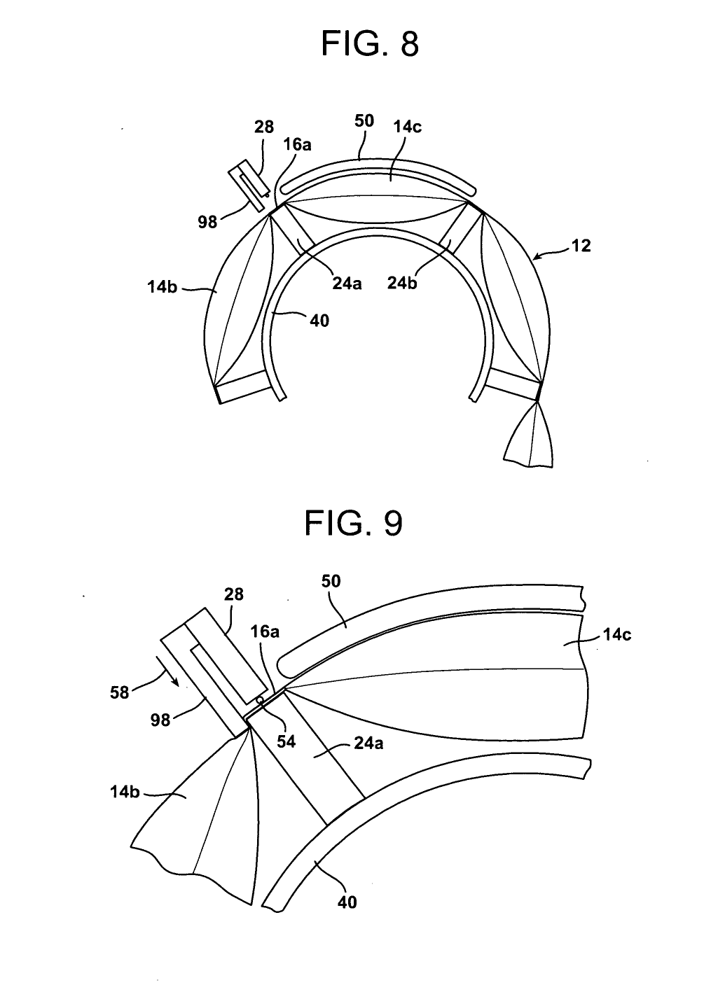

FIGS. 8-9 illustrate another feature that may be employed in accordance with the present invention, namely, a device 98 to apply tension to a desired or designated connector 16 during severance thereof. As illustrated, tension device 98 may take the form of a protruding bar, which may be affixed to the severing device 28. The tension device 98 may thus move in conjunction with the severing device 28. In this manner, when the severing device 28 is moved in direction 58 to urge connector 16a against standoff member 24a, the tension device 98 presses down on the container 14b to be severed from the web 12, which produces tension in the connector 16a that is designated for severance, by stretching such connector over the contact surface 62 of the standoff member 24a. Such tension of the connector designated for severance has been found to facilitate its severance. Top cover 50 may also be usefully employed with tension device 98, in that it may prevent the following container 14c from coming out of its ‘nest’ between standoffs 24a and 24b. Tension device 98 may be formed from various materials such as plastic (e.g., polyethylene), rubber, metal, etc., and may extend, e.g., from 0.25 to 0.75 inch past the heating element 54.

Referring once again to FIGS. 10-11, control system 22 will be described in further detail. As noted above, control system 22 includes an operator interface 30 to allow a specified number of containers 14 to be selected for severance from web 12. The control system 22 may further include a controller 100 and a sensor 102.

The specified number of containers to be selected for severance from the web may be as low as one and may be as high as desired, limited only by the total number of containers within the web 12. For packaging applications, the number will typically range from one to ten, e.g., from one to five. The operator interface 30 may be any type of device that allows an operator, e.g., a packaging specialist, to command machine 10 to sever a desired number of containers 14 from web 12. This may be a one-time severance or a series of severances to produce any desired number of, e.g., packaging cushions, wherein each packaging cushion comprises the desired number of containers 14.

For example, with reference to FIG. 10, a packaging specialist may desire a series of ten packaging cushions 104 to be severed from web 12, wherein each cushion 104 comprises three inflated containers 14. A bin 106 may be employed as shown to collect the packaging cushions 104 as they are severed from web 12. Alternatively, machine 10 may be positioned over a work station or conveyor to dispense cushions 104 at their point of use, e.g., directly into shipping containers.

Suitable devices for operator interface 30 may include, e.g., a control panel, which may be wall-mounted, floor-mounted, or mounted on machine 10, e.g., on stand 11; a foot or hand switch; a hand-held or belt-mounted remote-control device; a remotely operated computer or other such device, which allows one or more machines 10 to be operated from another room, another building, another town; etc. Controller 100 may comprise a printed circuit assembly, programmable logic controller (PLC), a personal computer (PC), or other such device commonly used in machines of the type to which the present invention pertains.

Once the operator inputs the desired number of containers for severance from the web, the controller 100 must determine which of the connectors 16 must be severed so that the resultant packaging cushion(s) 104 contains the correct number of containers 14. In accordance with the present invention, therefore, control system 22 is operative to identify a designated connector for severance, which corresponds to the selected number of containers to be severed from web 12.

Using FIG. 10 again as an example, the operator has selected three containers to be severed from the web 12, to produce a series of packaging cushions 104, wherein each cushion contains three inflated containers 14. As shown, a packaging cushion 104′ has just been severed from web 12. This was accomplished by severing mechanism 20, which severed the connector between container 14′ and container 14″, resulting in cushion 104′ having three containers 14, including container 14′ as the third container in the cushion. In order to make the next packaging cushion in the series with three containers, with container 14″ being the first container in that cushion, control system 22 will have to identify the correct connector to sever, and designate that connector for severance by severing mechanism 20. As may be appreciated from FIG. 10, the appropriate connector to be designated for severance is the connector identified as connector 16′. That is, the severance of connector 16′ corresponds to the selected number of containers 14, i.e., three (in this example), to be severed from the web the next time that the severing mechanism 20 is actuated.

In some embodiments, control system 22 identifies the designated connector for severance by counting the containers 14 passing by a fixed point. Once the selected number of containers have passed such point, the controller causes the severing mechanism sever the web at the designated connector. One technique for counting containers is to include sensor 102 as a counting device to count the standoff members 24 that pass the sensor as the rotary device 18 rotates. Advantageously, by counting the standoff members, even if a rotary device is changed to accommodate different container sizes (see, e.g., FIG. 3; device 18a vs. 18b), the correct number of containers is still counted because of the one-to-one correspondence between connectors/containers and standoff members.

Sensor 102 may thus be positioned as shown in FIG. 11 (note that the view of machine 10 in FIG. 11 is from the opposing side of the machine as shown in FIG. 10). Sensor 102 may be a photo eye, a proximity switch, or other means to detect the standoff members. Alternatively, the sensor could be positioned to detect the guide slots 86 or markings on rotary device 18 that correspond to the standoff members.

Accordingly, after the severance shown in FIG. 10 is made, the control system 22 will cause rotary device 18 rotate sufficiently to bring designated connector 16′ into position for severance, in which the designated connector 16′ is supported by one of the standoff members 24 and is located proximate the severing mechanism 20. As shown in FIG. 10, for example, the standoff member that will contact and support the designated connector 16′ is standoff member 24′. With the control system 22 as schematically shown in FIG. 11, controller 100 thus sends a signal to motor 48, causing the motor to rotate the rotary device 18. Sensor 102 sends a signal to controller 100 each time that a standoff member 24 passes the sensor. The third standoff member that will be detected in this example is standoff member 24′. Once standoff member 24′ is detected by sensor 102, controller 100 “knows” that such standoff member, which is supporting designated connector 16′, is on the way to severing mechanism 20. The controller 100 then sends a signal to motor 48 to stop rotating the rotary member 18. The timing of this ‘stop’ signal to motor 48 is such that standoff member 24′ brings the designated connector 16′ to a position for severance, i.e., proximate the severing mechanism 20, when the rotary device 18 stops rotating. For example, FIG. 1 shows connector 16a in a position for severance proximate severing mechanism 20.

In some embodiments, the rotary member 18 may continue to rotate for a given period of time after motor 48 stops driving the rotation of the rotary member. The amount of this inertia-driven rotation may be included in the program logic for the controller 100 so that the ‘stop’ signal is sent to motor 48 at the correct time following the input of the signal from sensor 102 of the detection of the standoff member 24 carrying the designated connector. Fine tuning can be accomplished as necessary, e.g., by mechanically adjusting the position of the sensor 102 so that enough time is available for the sensor to detect the standoff member carrying the designated connector, relay this to the controller, and then allow the controller to relay the stop signal to the motor 48.

Alternatively, an encoder may be used in association with motor 48, which supplies a predetermined number of pulses to controller 100 for each revolution of drive wheel 44. By programming in the total arcuate distance traversed by cylinder 40 for each revolution of drive wheel 44, the arcuate distance between each of the standoff members 24, and the amount of inertia-driven rotation of cylinder 40 after the motor 48 stops driving the cylinder, the controller 100 can more accurately time the transmission of the ‘stop’ signal to motor 48 following the input of the signal from sensor 102 of the detection of the standoff member 24 carrying the designated connector.

Once the designated connector has been delivered by rotary device 18 to a position for severance, control system 22 then causes severing mechanism 20 to move severing device 28 such that the severing device urges the designated connector against the supporting standoff member 24 (e.g., as shown in FIG. 9, relative to connector 16a), thereby severing the web 12 at such designated connector. With reference again to FIGS. 10-11, once the standoff member 24′ brings the designated connector 16′ to a position for severance, i.e., proximate the severing mechanism 20, controller 100 sends a signal to actuator 52, which causes the actuator to move the severing mechanism 28 to urge the designated connector 16′ against standoff member 24′, thereby causing its severance.

If additional packaging cushions 104 are desired, e.g., as remaining in a series as specified by the operator, the controller 100 would next send a signal to motor 48, to cause the motor to turn the rotary device 18 to deliver the next designated connector, corresponding to the selected number of containers to be severed from the web, e.g., three, to the severing mechanism 20.

The aforedescribed cycle repeats until the total number of requested packaging cushions 104 have been severed from web 12.

In an alternative embodiment, severing mechanism 20 may be configured to only partially sever web 12. In this embodiment, most of the width of the web 12 is severed at a connector 16, leaving a small unsevered portion that can be easily torn by an operator when desired.

A method in accordance with the present invention thus includes the following steps:

a. contacting the web 12 with a rotary device 18 comprising a plurality of spaced-apart standoff members 24 extending radially outwards, wherein the standoff members 24 contact the web 12 at the connectors 16 such that rotational movement of the rotary device 18 causes movement of the web 12;

b. selecting a specified number of containers 14 for severance from the web 12;

c. identifying a designated connector for severance, e.g., connector 16′, which corresponds to the selected number of containers 14 to be severed from the web;

d. moving the web 12 until the designated connector 16′ is placed into a position for severance, in which such designated connector is supported by one of the standoff members, e.g., standoff member 24′, and is located proximate severing mechanism 20 with movable severing device 28; and

e. moving the severing device 28 such that the severing device urges the designated connector 16′ against the supporting standoff member 24′, thereby severing the web 12 at the designated connector 16′.

The foregoing description of preferred embodiments of the invention has been presented for purposes of illustration and description. It is not intended to be exhaustive or to limit the invention to the precise form disclosed, and modifications and variations are possible in light of the above teachings or may be acquired from practice of the invention.

What is claimed is:

1. A machine for severing a web comprising a series of containers, said containers being spaced apart and linked together by a series of connectors disposed between the containers, said machine comprising:
a. a rotary device comprising a plurality of spaced-apart standoff members extending radially outwards to contact the web at the connectors such that rotational movement of said rotary device causes movement of the web;
b. a severing mechanism including a movable severing device that is adapted to urge the web against one of said standoff members to thereby effect severance of the web; and
c. a control system comprising an operator interface to allow a specified number of containers to be selected for severance from the web, said control system being operative to:
(1) identify a designated connector for severance which corresponds to said selected number of containers to be severed from the web,
(2) cause said rotary device to bring said designated connector into a position for severance, in which said designated connector is supported by one of said standoff members and is located proximate said severing mechanism, and
(3) cause said severing mechanism to move said severing device such that the severing device urges said designated connector against the supporting standoff member, thereby severing the web at the designated connector.

2. The machine of claim 1, wherein said severing device comprises a heating element capable of reaching a temperature sufficient to sever the web.

3. The machine of claim 1, wherein said containers comprise gas-filled packaging cushions.

4. The machine of claim 1, further comprising an alignment member to align said severing device with one of said standoff members during severance of the web.

5. The machine of claim 1, wherein each of said standoff members includes a contact surface to contact the web at the connectors, said contact surface also providing a support against which the severing device urges the designated connector during severance thereof.

6. The machine of claim 1, wherein said control system includes a counting device to facilitate the identification of said designated connector for severance.

7. The machine of claim 1, further including a device to apply tension to said designated connector during severance thereof.

8. The machine of claim 1, wherein said severing mechanism partially severs said web.

9. The machine of claim 1, wherein said severing device moves in a substantially linear path of travel.

10. A method for severing a web comprising a series of containers, said containers being spaced apart and linked together by a series of connectors disposed between the containers, said method comprising:
a. contacting the web with a rotary device comprising a plurality of spaced-apart standoff members extending radially outwards, said standoff members contacting the web at the connectors such that rotational movement of said rotary device causes movement of the web;
b. selecting a specified number of containers for severance from the web;
c. identifying a designated connector for severance, which corresponds to said selected number of containers to be severed from the web;
d. moving the web until said designated connector is placed into a position for severance, in which said designated connector is supported by one of said standoff members and is located proximate a severing mechanism, said severing mechanism including a movable severing device; and
e. moving said severing device such that the severing device urges said designated connector against the supporting standoff member, thereby severing the web at the designated connector.

11. A system for making and severing a web comprising a series of containers, comprising:
a. an apparatus for making the web, said containers being spaced apart and linked together by a series of connectors disposed between the containers; and
b. a machine for severing the web, said machine comprising:
(1) a rotary device comprising a plurality of spaced-apart standoff members extending radially outwards to contact the web at the connectors such that rotational movement of said rotary device causes movement of the web,
(2) a severing mechanism including a movable severing device that is adapted to urge the web against one of said standoff members to thereby effect severance of the web, and
(3) a control system comprising an operator interface to allow a specified number of containers to be selected for severance from the web, said control system being operative to:
(a) identify a designated connector for severance which corresponds to said selected number of containers to be severed from the web,
(b) cause said rotary device to bring said designated connector into a position for severance, in which said designated connector is supported by one of said standoff members and is located proximate said severing mechanism, and
(c) cause said severing mechanism to move said severing device such that the severing device urges said designated connector against the supporting standoff member, thereby severing the web at the designated connector.
